(19) United States
(12) Patent Application Publication
(10) Pub. No.: US 2012/0189896 A1
(43) Pub. Date: Jul. 26, 2012

(54) ELECTRODE SEPARATOR

(75) Inventors: Hongxia Zhou, Ann Arbor, MI (US); George William Adamson, Camarillo, CA (US); Biying Huang, Fremont, CA (US)

(73) Assignee: ZPower, LLC, Camarillo, CA (US)

(21) Appl. No.: 13/259,259

(22) PCT Filed: Mar. 17, 2010
(86) PCT No.: PCT/US2010/027636

§ 371 Date: Nov. 15, 2011

Related U.S. Application Data
(60) Provisional application No. 61/164,051, filed on Mar. 27, 2009.
(60) Provisional application No. 61/163,884, filed on Mar. 27, 2009.

(51) Int. Cl. H01M 2/16; B32B 37/06

(52) U.S. Cl. 429/144; 156/275.5

(57) ABSTRACT

The present invention provides a separator for use in an alkaline electrochemical cell comprising a QA polymer material, wherein the separator is substantially resistant to oxidation by silver oxide.

### CROSS REFERENCE TO RELATED APPLICATIONS

This PCT application claims priority to U.S. Application No. 61/164,051, filed on Mar. 27, 2009, and U.S. Application No. 61/163,884, filed on Mar. 27, 2009. The entire contents of the aforementioned applications are incorporated herein by reference in their entireties.

### FIELD OF THE INVENTION

This invention is concerned with electric storage batteries, and in particular, with separators for alkaline batteries and methods of making the same.

### BACKGROUND

An electrical storage battery comprises one electrochemical cell or a plurality of electrochemical cells of the same type, the latter typically being connected in series to provide a higher voltage or in parallel to provide a higher charge capacity than provided by a single cell. An electrochemical cell comprises an electrolyte interposed between and in contact with an anode and a cathode. For a storage battery, the anode comprises an active material that is readily oxidized, and the cathode comprises an active material that is readily reduced. During battery discharge, the anode active material is oxidized and the cathode active material is reduced, so that electrons flow from the anode through an external load to the cathode, and ions flow through the electrolyte between the electrodes.

Many electrochemical cells used for electrical storage applications also include a separator between the anode and the cathode is required to prevent reactants and reaction products present at one electrode from reacting and/or interfering with reactions at the other electrode. To be effective, a battery separator must be electronically insulating, and remain so during the life of the battery, to avoid battery self-discharge via internal shorting between the electrodes. In addition, a battery separator must be both an effective electrolyte transport barrier and a sufficiently good ionic conductor to avoid excessive separator resistance that substantially lowers the discharge voltage.

Electrical storage batteries are classified as either “primary” or “secondary” batteries. Primary batteries involve at least one irreversible electrode reaction and cannot be recharged with useful charge efficiency by applying a reverse voltage. Secondary batteries involve relatively reversible electrode reactions and can be recharged with acceptable loss of charge capacity over numerous charge-discharge cycles. Separator requirements for secondary batteries tend to be more demanding since the separator must survive repeated charge-discharge cycles.

For secondary batteries comprising a highly oxidative cathode, a highly reducing anode, and an alkaline electrolyte, separator requirements are particularly stringent. The separator must be chemically stable in strongly alkaline solution, resist oxidation in contact with the highly oxidizing cathode, and resist reduction in contact with the highly reducing anode. Since ions, especially metal oxide ions, from the cathode can be somewhat soluble in alkaline solutions and tend to be chemically reduced to metal on separator surfaces, the separator must also inhibit transport and/or chemical reduction of metal ions. Otherwise, a buildup of metal deposits within separator pores can increase the separator resistance in the short term and ultimately lead to shorting failure due to formation of a continuous metal path through the separator. In addition, because of the strong tendency of anodes to form dendrites during charging, the separator must suppress dendritic growth and/or resist dendrite penetration to avoid failure due to formation of a dendritic short between the electrodes. A related issue with anodes is shape change, in which the central part of the electrode tends to thicken during charge-discharge cycling. The causes of shape change are complicated and not well-understood but apparently involve differentials in the current distribution and solution mass transport along the electrode surface. The separator preferably mitigates zinc electrode shape change by exhibiting uniform and stable ionic conductivity and ionic transport properties.

In order to satisfy the numerous and often conflicting separator requirements for zinc-silver oxide batteries, a separator stack comprised of a plurality of separators that perform specific functions is needed. Some of the required functions are resistance to electrochemical oxidation and silver ion transport from the cathode, and resistance to electrochemical reduction and dendrite penetration from the anode.

Traditional separators decompose chemically in alkaline electrolytes, which limits the useful life of the battery. Traditional separators are also subject to chemical oxidation by soluble silver ions and electrochemical oxidation in contact with silver electrodes. Furthermore, some traditional separators exhibit low mechanical strength and poor resistance to penetration by dendrites.

To solve some of the problems caused by traditional separators, new separator materials have been developed.

### SUMMARY OF THE INVENTION

One aspect of the present invention provides a multilayered separator for use in an alkaline electrochemical cell comprising a first active layer comprising a PVA polymer material; and a second active layer comprising a quaternary polymer material or a PSA polymer material, wherein the first active layer and the second active layer are provided to form a unitary structure that is substantially resistant to oxidation by silver oxide. In several embodiments, the second active layer of the separator further comprises a QA polymer material. In some embodiments, the QA polymer material comprises a QA homopolymer or a QA co-polymer. For example, the QA polymer material comprises a QA homopolymer. In other examples, the QA polymer material comprises poly[(2-ethyldimethylammonioethyl methacrylate ethyl sulfate)-co-(1-vinylpyrrolidone)], poly((2-dimethylamino)ethyl methacrylate)methyl chloride quaternary salt, poly(acrylamide-co-diallyldimethylammonium chloride), poly(diallyldimethylammonium chloride), poly(dimethylamine-co-epichlorohydrin-co-ethylenediamine), or mixtures thereof.

In some embodiments, the second active layer comprises a quaternary QP polymer material. For example, the QP polymer material comprises a homopolymer or a co-polymer. In some instances, the QP polymer comprises a QP co-polymer. In other instances, the QP polymer comprises a poly(arylene phenyl phosphineoxide ether sulfone) terpolymer. Or, the QP polymer comprises a quaternary alkyl phosphonium halide salt of Formula C (defined below). And in some embodiments, the QP polymer comprises a poly phosphine oxide. For example, the QP polymer comprises a poly(arylene phosphine oxide).

In some embodiments, the second active layer further comprises a PSA polymer. In some embodiments, the PSA polymer material further comprises a PSA homopolymer, a PSA co-polymer, or a mixture of PSA homopolymer or PSA co-polymer and another polymer or co-polymer. In other embodiments, the PSA polymer material comprises a polyvinyl sulfonic acid. For instance, the PSA polymer material comprises a polystyrene sulfonic acid homopolymer.

In some embodiments, the first active layer or the second active layer are independently cross-linked.

In other embodiments, the first active layer further comprises a filler. For example, the filler comprises a metal oxide powder, a silicate powder, or a combination thereof. In other examples, the filler comprises a powder of zirconium oxide, titanium oxide, aluminum oxide, silicon oxide, aluminosilicate, calcium oxide, magnesium oxide, strontium oxide, barium oxide, or any combination thereof. For instance, the filler comprises zirconium oxide powder. In some embodiments, the filler further comprises from about 5 wt % to about 50 wt % of zirconium oxide powder by weight of the PVA polymer material.

In alternative embodiments, the PVA polymer material further comprises a PVA homopolymer, a PVA co-polymer, or a mixture of PVA homopolymer or PVA co-polymer and another polymer or co-polymer. For example, the PVA polymer material further comprises a PVA co-polymer. In other examples, the PVA co-polymer comprises polyvinyl alcohol-co-polyvinylsulfonic acid. And, in some examples, the PVA co-polymer further comprises polyvinyl alcohol-co-polystyrene sulfonic acid. For instance, the PVA co-polymer further comprises polyvinyl alcohol-co-polystyrene sulfonic acid, and the polyvinyl alcohol is present in a concentration of at from about 10 wt % to about 60 wt % by weight of the co-polymer. In some embodiments, the PVA polymer material further comprises PVA that is at least about 70% hydrolyzed. In others, the PVA polymer material further comprises PVA having an average molecular weight of at least about 80,000 amu. In some embodiments, the PVA polymer material further comprises a mixture of PVA homopolymer or PVA co-polymer and at least one additional homopolymer or co-polymer. For instance, the PVA polymer material further comprises a mixture of PVA homopolymer and polyvinylsulfonic acid, polyacrylic acid, acrylic acid co-polymer, polyacrylamide, acrylamide co-polymer, polyvinyl amine, vinyl amine co-polymer, maleic acid co-polymer, maleic anhydride co-polymer, polyvinyl ether, vinyl ether co-polymer, polyethylene glycol, ethylene glycol co-polymer, polypropylene glycol, polypropylene glycol co-polymer, sulfonated polysulfone, sulfonated polyethersulfone, sulfonated polyetheretherketone, polyallyl ether, polydivinylbenzene, or triallyltriazine. In some embodiments, the PVA polymer material further comprises a PVA homopolymer.

In alternative embodiments, the second active layer further comprises a filler. For example, the filler comprises a metal oxide powder, a silicate powder, or a combination thereof. In some examples, the filler comprises a metal oxide powder. For instance, the metal oxide powder comprises zirconium oxide, titanium oxide, aluminum oxide, silicon oxide, aluminosilicate, calcium oxide, magnesium oxide, strontium oxide, barium oxide, or any combination thereof. In other instances, the filler comprises zirconium oxide powder.

In some embodiments, the separator further comprises a third layer that comprises a second PVA polymer material.

In some embodiments, the first active layer and the second active layer are cross-linked together.

Another aspect of the present invention provides a multilayered separator for use in an alkaline electrochemical cell comprising a first active layer comprising a first PVA polymer material; a second active layer comprising a QA polymer material or a PSA polymer material; and a third active layer comprising a second PVA polymer material, wherein the first active layer and the second active layer are independently cross-linked to form a unitary structure that is substantially resistant to oxidation by silver oxide.

In several embodiments, the second active layer further comprises a QA polymer. And, in some embodiments, the QA polymer comprises a QA homopolymer or a QA co-polymer. For example, the QA polymer comprises a QA homopolymer. In other examples, the QA polymer comprises poly[(2-ethyldimethylammonioethyl methacrylate ethyl sulfate)-co-(1-vinylpyrrolidone)], poly((2-dimethylamino)ethyl methacrylate)methyl chloride quaternary salt, poly(acrylamide-co-diallyldimethylammonium chloride), poly(diallyldimethylammonium chloride), poly(dimethylamine-co-epichlorohydrin-co-ethylenediamine), or mixtures thereof.

In some embodiments, the second active layer further comprises a PSA polymer. For example, the PSA polymer material further comprises a PSA homopolymer, a PSA co-polymer, or a mixture of PSA homopolymer or PSA co-polymer and another polymer or co-polymer. In other examples, the PSA polymer material comprises a polyvinyl sulfonic acid. For instance, the PSA polymer material comprises a polystyrene sulfonic acid homopolymer. In some embodiments, the first PVA polymer material comprises a PVA co-polymer. In others, the first PVA polymer material comprises a co-polymer further comprising polyvinyl alcohol-co-polyvinylsulfonic acid. In some embodiments, the polyvinyl alcohol-co-polyvinylsulfonic acid is polyvinyl alcohol-co-polystyrene sulfonic acid. In other embodiments, the first PVA polymer material further comprises zirconium oxide.

In some embodiments, the third active layer comprises a second PVA polymer material, and the second PVA polymer material comprises PVA homopolymer. And, in some embodiments, the second PVA polymer material comprises a PVA homopolymer that is cross-linked. For example, the PVA homopolymer is cross-linked to the first active layer, the second active layer, or both.

Another aspect of the present invention provides a multilayered separator for use in an alkaline electrochemical cell comprising a first active layer comprising a PVA-co-PSA and zirconium oxide powder; a second active layer comprising PSA homopolymer; and a third active layer comprising cross-linked PVA homopolymer, wherein each of the first, second and third active layers are independently cross-linked. In several embodiments, the first active layer is also cross-linked with the second active layer, the third active layer, or both.

Another aspect of the present invention provides a multilayered separator for use in an alkaline electrochemical cell comprising a first active layer comprising PVA homopolymer and zirconium oxide powder; and a second active layer comprising PSA homopolymer, wherein the first active layer and the second active layer are independently cross-linked, and the first active layer is cross-linked with the second active layer to form a unitary structure that is substantially resistant to oxidation by silver oxide.

Another aspect of the present invention provides a method of manufacturing a multilayered separator comprising the steps of providing a first active layer comprising a PVA polymer material; providing a second active layer comprising PSA polymer material; and independently cross-linking the first active layer and the second active layer to form a unitary structure that is substantially resistant to oxidation by silver oxide.

In several methods, the first active layer is co-extruded with the second active layer to form a co-extrusion. In other methods, the first active layer or the second active layer is independently cross-linked by incorporation of a cross-linking agent into the polymer material comprising the active layer. In some methods, the co-extrusion is irradiated by exposure to an electron beam providing a radiation dosage of from about 100 kilograys to about 200 kilograys and from about 250 kilovolts to about 350 kilovolts.

Another aspect of the present invention provides a method of manufacturing a multilayered separator comprising providing a first active layer comprising a PVA polymer material; providing a second active layer comprising PSA polymer material; and irradiating the first active layer and the second active layer such that the first active layer and the second active layer are independently cross-linked, and the first active layer is cross-linked with the second active layer. In some methods, the PVA polymer material further comprises a filler. For example, the filler comprises a metal oxide powder, a silicate powder, or a combination thereof. In other examples, the filler comprises a powder of zirconium oxide, titanium oxide, aluminum oxide, silicon oxide, aluminosilicate, calcium oxide, magnesium oxide, strontium oxide, barium oxide, or any combination thereof. For instance, the filler comprises zirconium oxide powder. And in other instances, the filler further comprises from about 5 wt % to about 50 wt % of zirconium oxide powder by weight of the PVA polymer material. In some methods, the PVA polymer material further comprises a PVA co-polymer. For example, the PVA co-polymer comprises polyvinyl alcohol-co-polyvinylsulfonic acid. In other examples, the PVA co-polymer further comprises polyvinyl alcohol-co-polystyrene sulfonic acid. In some examples, the PVA co-polymer further comprises polyvinyl alcohol-co-polystyrene sulfonic acid, and the polyvinyl alcohol is present in a concentration of at from about 10 wt % to about 60 wt % by weight of the co-polymer. In several embodiments, the PVA polymer material further comprises a mixture of PVA homopolymer or PVA co-polymer and at least one additional homopolymer or co-polymer. Alternatively, the PVA polymer material further comprises a mixture of PVA homopolymer and polyvinylsulfonic acid, polyacrylic acid, acrylic acid co-polymer, polyacrylamide, acrylamide co-polymer, polyvinyl amine, vinyl amine co-polymer, maleic acid co-polymer, maleic anhydride co-polymer, polyvinyl ether, vinyl ether co-polymer, polyethylene glycol, ethylene glycol co-polymer, polypropylene glycol, polypropylene glycol co-polymer, sulfonated polysulfone, sulfonated polyethersulfone, sulfonated polyetheretherketone, polyallyl ether, polydivinylbenzene, or triallyltriazine. In some embodiments, the PVA polymer material further comprises a PVA homopolymer.

In some embodiments, the PSA polymer material further comprises a PSA homopolymer, a PSA co-polymer, or a mixture of PSA homopolymer or PSA co-polymer and another polymer or co-polymer. For example, the PSA polymer material comprises polystyrene sulfonic acid homopolymer.

Some methods further comprise providing a third layer that comprises a second PVA polymer material.

Another aspect of the present invention provides an electrochemical cell comprising:

a cathode that comprises silver oxide, an anode that comprises zinc, an electrolyte, and a multilayered separator that comprises a first active layer comprising a PVA polymer material and a second active layer comprising a PSA polymer material, wherein the active layers are independently cross-linked, and the electrochemical cell is configured such that the second active layer is adjacent to the cathode.

Another aspect of the present invention provides an electrochemical cell comprising a cathode that comprises silver oxide, an anode that comprises zinc, an electrolyte, and a multilayered separator that comprises a first active layer comprising a PVA polymer material and a second active layer comprising a QA polymer material, wherein the active layers are independently cross-linked, and the electrochemical cell is configured such that the second active layer is adjacent to the cathode.

Another aspect of the present invention provides an electrochemical cell comprising:

a cathode that comprises silver oxide, an anode that comprises zinc, an electrolyte, and a multilayered separator that comprises a first active layer comprising a PVA polymer material and a second active layer comprising a QP polymer material, wherein the active layers are independently cross-linked, and the electrochemical cell is configured such that the second active layer is adjacent to the cathode.

### BRIEF DESCRIPTION OF THE FIGURES

FIG. 1 illustrates a production assembly that practices one exemplary method of the present invention.

This FIGURE is not to scale and some features have been enlarged for better depiction of the features and operation of the invention. Furthermore, this FIGURES is by way of example and is not intended to limit the scope of the present invention.

### DETAILED DESCRIPTION

The present invention provides a separator for use in an alkaline electrochemical cell comprising a QA polymer material, wherein the separator is substantially resistant to oxidation by silver oxide.

### I. DEFINITIONS

As used herein, “substantially resistant to oxidation by silver oxide” refers to a chemical property of a separator (e.g., a single layered separator or a multilayered separator) or an active layer thereof, wherein the separator or active layer is substantially inert to chemical oxidation by silver oxide. For example, the separator or active layer is inert to chemical oxidation by silver oxide for a period of at least 1 day and a temperature of at least 40° C. (e.g., at least 45° C., at least 50° C., or at least 60° C.).

As used herein, “cross-link” or “cross-linked” refers to a covalent bond between two or more polymer chains, or a structural property wherein two or more polymer chains are covalently bonded together. Cross-links can be formed by chemical reactions that are initiated by heat, pressure, or radiation. Cross-links typically bond one or more chemical moieties attached to a polymer backbone with one or more chemical moiety attached to the backbone of another polymer.

As used herein, “independently cross-linked” and “internally cross-linked” are used interchangeably and refer to a structural property of an active layer comprising a polymer material (e.g., a PVA polymer material or a PSA polymer material), wherein at least one polymer chain (e.g., a PVA polymer chain or PSA polymer chain) in the active layer is cross-linked with another polymer chain within the same active layer. For example, an independently cross-linked first active layer, which comprises a PVA polymer material is one in which a PVA polymer chain in the first active layer is cross-linked with another polymer chain in the first active layer. Or, an independently cross-linked second active layer, which comprises a PSA polymer material is one in which a PSA polymer chain in the second active layer is cross-linked with another polymer chain in the second active layer. It is noted that the cross-links present in an independently cross-linked active layer include intra-layer bonds that join two polymer chains of approximately the same chemical composition, and intra-layer bonds that join two polymer chains of different chemical composition.

It is noted that ‘independently cross-linked’ active layers can undergo further cross-linking that cross-links polymer chains in one active layer with polymer chains in one or more adjacent active layers.

As used herein, “polyvinyl alcohol” and “PVA” are used interchangeably to refer to polymers, solutions for preparing polymers, and polymer coatings. Use of these terms in no way implies the absence of other constituents. These terms also encompass substituted and co-polymerized polymers. A substituted polymer denotes one for which a substituent group, a methyl group, for example, replaces a hydrogen on the polymer backbone.

As used herein, “polysulfonic acid” and “PSA” are used interchangeably to refer to polymers, solutions for preparing polymers, and polymer coatings. Use of these terms in no way implies the absence of other constituents. These terms also encompass substituted and co-polymerized polymers. A substituted polymer denotes one for which a substituent group, a methyl group, for example, replaces a hydrogen on the polymer backbone.

It is noted that PSA includes any polymer that includes at least one carbon atom in the polymer backbone, and at least one carbon atom of the polymer backbone is substituted with an R-group, which is also substituted with a sulfonate moiety or a sulfonic acid moiety depending on the pH of the environment; or, at least one carbon atom of the polymer backbone is substituted with an optionally substituted sulfonate. For example, many PSAs are polymers comprising a monomer of Formula (A):

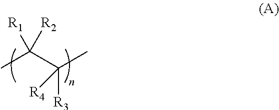

wherein each of R₁, R₂, R₃, and R₄ is independently —Z^{A}R₅, wherein each Z^{A} is independently selected from a bond or —SO₃—, or —SO₃⁻; each R₅ is independently selected from hydrogen; alkyl, aryl, or cycloalkyl, any of which are optionally substituted with —SO₃⁻ or —SO₃H, or R₅ is absent; provided that at least one of R₁, R₂, R₃, and R₄ is —SO₃—, —SO₃⁻, —SO₃H; or alkyl, aryl, or at least one of R₁, R₂, R₃, and R₄ is alkyl, aryl, or cycloalkyl substituted with at least one —SO₃⁻ or —SO₃H moiety. A PSA polymer material also includes monomers, such as those illustrated in Formula A, that are partially esterified.

For example, the PSA comprises a polymer comprising a monomer of Formula A, wherein each of R₃ and R₄ is hydrogen, R₁ is phenyl substituted with at least one of —SO₃⁻ or —SO₃H, and R₂ is hydrogen.

As used herein the term “aliphatic” encompasses the terms alkyl, alkenyl, alkynyl, each of which being optionally substituted as set forth below.

As used herein, an “alkyl” group refers to a saturated aliphatic hydrocarbon group containing 1-12 (e.g., 1-10, 1-8, 1-6, or 1-4) carbon atoms. An alkyl group can be straight or branched. Examples of alkyl groups include, but are not limited to, methyl, ethyl, propyl, isopropyl, butyl, isobutyl, sec-butyl, tert-butyl, n-pentyl, n-heptyl, or 2-ethylhexyl. An alkyl group can be substituted (i.e., optionally substituted) with one or more substituents such as halo, cycloaliphatic [e.g., cycloalkyl or cycloalkenyl], heterocycloaliphatic [e.g., heterocycloalkyl or heterocycloalkenyl], aryl, heteroaryl, or alkoxy, without limitation.

As used herein, an “alkenyl” group refers to an aliphatic carbon group that contains 2-8 (e.g., 2-12, 2-10, 2-6, or 2-4) carbon atoms and at least one double bond. Like an alkyl group, an alkenyl group can be straight or branched. Examples of an alkenyl group include, but are not limited to allyl, isoprenyl, 2-butenyl, and 2-hexenyl. An alkenyl group can be optionally substituted with one or more substituents such as halo, cycloaliphatic [e.g., cycloalkyl or cycloalkenyl], heterocycloaliphatic [e.g., heterocycloalkyl or heterocycloalkenyl], aryl, heteroaryl, or alkoxy, without limitation.

As used herein, an “alkynyl” group refers to an aliphatic carbon group that contains 2-8 (e.g., 2-12, 2-6, or 2-4) carbon atoms and has at least one triple bond. An alkynyl group can be straight or branched. Examples of an alkynyl group include, but are not limited to, propargyl and butynyl. An alkynyl group can be optionally substituted with one or more substituents such as those described above in the definitions of ‘alkyl’ and/or ‘alkenyl’.

As used herein, an “aryl” group used alone or as part of a larger moiety as in “aralkyl”, “aralkoxy”, or “aryloxyalkyl” refers to monocyclic (e.g., phenyl); bicyclic (e.g., indenyl, naphthalenyl, tetrahydronaphthyl, tetrahydroindenyl); and tricyclic (e.g., fluorenyl tetrahydrofluorenyl, or tetrahydroanthracenyl, anthracenyl) ring systems in which the monocyclic ring system is aromatic or at least one of the rings in a bicyclic or tricyclic ring system is aromatic. The bicyclic and tricyclic groups include benzofused 2-3 membered carbocyclic rings. For example, a benzofused group includes phenyl fused with two or more C₄₋₈ carbocyclic moieties. An aryl is optionally substituted with one or more substituents including aliphatic [e.g., alkyl, alkenyl, or alkynyl]; cycloaliphatic; (cycloaliphatic)aliphatic; heterocycloaliphatic; (heterocycloaliphatic)aliphatic; aryl; heteroaryl; alkoxy; or the like.

The term “battery” encompasses electrical storage devices comprising one electrochemical cell or a plurality of electrochemical cells. A “secondary battery” is rechargeable, whereas a “primary battery” is not rechargeable. For secondary batteries of the present invention, a battery anode is designated as the positive electrode during discharge, and as the negative electrode during charge.

The term “alkaline battery” refers to a primary battery or a secondary battery, wherein the primary or secondary battery comprises an alkaline electrolyte.

As used herein, an “electrolyte” refers to a substance that behaves as an electrically conductive medium. For example, the electrolyte facilitates the mobilization of electrons and cations in the cell. Electrolytes include mixtures of materials such as aqueous solutions of alkaline agents. Such alkaline electrolytes can also comprise additives such as buffers. For example, an alkaline electrolyte comprises a buffer comprising a borate or a phosphate. Exemplary alkaline electrolytes include, without limitation aqueous KOH, aqueous NaOH, or the liquid mixture of KOH in a polymer.

As used herein, “alkaline agent” refers to a base or ionic salt of an alkali metal (e.g., an aqueous hydroxide of an alkali metal). Furthermore, an alkaline agent forms hydroxide ions when dissolved in water or other polar solvents. Exemplary alkaline electrolytes include without limitation LiOH, NaOH, KOH, CsOH, RbOH, or combinations thereof.

A “cycle” refers to a single charge and discharge of a battery.

As used herein, “polyvinylidene fluoride” and “PVDF” are used interchangeably to refer to polymers, solutions for preparing polymers, and polymer coatings comprising PVDF. Use of these terms in no way implies the absence of other constituents. These terms also encompass substituted and co-polymerized polymers. A substituted polymer denotes one for which a substituent group, a methyl group, for example, replaces a hydrogen on the polymer backbone.

As used herein, “polytetrafluoroethylene” and “PTFE” are used interchangeably to refer to polymers, solutions for preparing polymers, and polymer coatings. Use of these terms in no way implies the absence of other constituents. These terms also encompass substituted and co-polymerized polymers. A substituted polymer denotes one for which a substituent group, a methyl group, for example, replaces a hydrogen on the polymer backbone.

As used herein, “Ah” refers to Ampere (Amp) Hour and is a scientific unit for the capacity of a battery or electrochemical cell. A derivative unit, “mAh” represents a milliamp hour and is 1/1000 of an Ah.

As used herein, “maximum voltage” or “rated voltage” refers to the maximum voltage an electrochemical cell can be charged without interfering with the cell's intended utility. For example, in several zinc-silver electrochemical cells that are useful in portable electronic devices, the maximum voltage is less than about 3.0 V (e.g., less than about 2.8 V, less than about 2.5 V, about 2.3 V or less, or about 2.0 V). In other batteries, such as lithium ion batteries that are useful in portable electronic devices, the maximum voltage is less than about 15.0 V (e.g., less than about 13.0 V, or about 12.6 V or less). The maximum voltage for a battery can vary depending on the number of charge cycles constituting the battery's useful life, the shelf-life of the battery, the power demands of the battery, the configuration of the electrodes in the battery, and the amount of active materials used in the battery.

As used herein, an “anode” is an electrode through which (positive) electric current flows into a polarized electrical device. In a battery or galvanic cell, the anode is the negative electrode from which electrons flow during the discharging phase in the battery. The anode is also the electrode that undergoes chemical oxidation during the discharging phase. However, in secondary, or rechargeable, cells, the anode is the electrode that undergoes chemical reduction during the cell's charging phase. Anodes are formed from electrically conductive or semiconductive materials, e.g., metals, metal oxides, metal alloys, metal composites, semiconductors, or the like. Common anode materials include Si, Sn, Al, Ti, Mg, Fe, Bi, Zn, Sb, Ni, Pb, Li, Zr, Hg, Cd, Cu, LiC₆, mischmetals, alloys thereof, oxides thereof, or composites thereof.

Anodes can have many configurations. For example, an anode can be configured from a conductive mesh or grid that is coated with one or more anode materials. In another example, an anode can be a solid sheet or bar of anode material.

As used herein, a “cathode” is an electrode from which (positive) electric current flows out of a polarized electrical device. In a battery or galvanic cell, the cathode is the positive electrode into which electrons flow during the discharging phase in the battery. The cathode is also the electrode that undergoes chemical reduction during the discharging phase. However, in secondary or rechargeable cells, the cathode is the electrode that undergoes chemical oxidation during the cell's charging phase. Cathodes are formed from electrically conductive or semiconductive materials, e.g., metals, metal oxides, metal alloys, metal composites, semiconductors, or the like. Common cathode materials include AgO, Ag₂O, HgO, Hg₂O, CuO, CdO, NiOOH, Pb₂O₄, PbO₂, LiFePO₄, Li₃V₂(PO₄)₃, V₆O₁₃, V₂O₅, Fe₃O₄, Fe₂O₃, MnO₂, LiCoO₂, LiNiO₂, LiMn₂O₄, or composites thereof.

Cathodes can also have many configurations. For example, a cathode can be configured from a conductive mesh that is coated with one or more cathode materials. In another example, a cathode can be a solid sheet or bar of cathode material.

As used herein, an “electronic device” is any device that is powered by electricity. For example, and electronic device can include a portable computer, a portable music player, a cellular phone, a portable video player, or any device that combines the operational features thereof.

As used herein, “cycle life” is the maximum number of times a secondary battery can be charged and discharged.

The symbol “M” denotes molar concentration.

Batteries and battery electrodes are denoted with respect to the active materials in the fully-charged state. For example, a zinc-silver oxide battery comprises an anode comprising zinc and a cathode comprising silver oxide. Nonetheless, more than one species is present at a battery electrode under most conditions. For example, a zinc electrode generally comprises zinc metal and zinc oxide (except when fully charged), and a silver oxide electrode usually comprises silver oxide (AgO and/or Ag₂O) and silver metal (except when fully discharged).

The term “oxide” applied to alkaline batteries and alkaline battery electrodes encompasses corresponding “hydroxide” species, which are typically present, at least under some conditions.

As used herein, “charge profile” refers to a graph of an electrochemical cell's voltage or capacity with time. A charge profile can be superimposed on other graphs such as those including data points such as charge cycles or the like.

As used herein, “resistivity” or “impedance” refers to the internal resistance of a cathode in an electrochemical cell. This property is typically expressed in units of Ohms or micro-Ohms.

As used herein, the terms “first” and/or “second” do not refer to order or denote relative positions in space or time, but these terms are used to distinguish between two different elements or components. For example, a first separator does not necessarily proceed a second separator in time or space; however, the first separator is not the second separator and vice versa. Although it is possible for a first separator to proceed a second separator in space or time, it is equally possible that a second separator proceeds a first separator in space or time.

As used herein, “polyether” and “PE” are used interchangeably to refer to polymers, solutions for preparing polymers, and polymer coatings. Use of these terms in no way implies the absence of other constituents. These terms also encompass substituted and co-polymerized polymers. A substituted polymer denotes one for which a substituent group, a methyl group, for example, replaces a hydrogen on the polymer backbone.

As used herein, “polyethylene oxide” and “PEO” are used interchangeably to refer to polymers, solutions for preparing polymers, and polymer coatings. Use of these terms in no way implies the absence of other constituents. These terms also encompass substituted and co-polymerized polymers. A substituted polymer denotes one for which a substituent group, a methyl group, for example, replaces a hydrogen on the polymer backbone.

As used herein, “polypropylene oxide” and “PPO” are used interchangeably to refer to polymers, solutions for preparing polymers, and polymer coatings. Use of these terms in no way implies the absence of other constituents. These terms also encompass substituted and co-polymerized polymers. A substituted polymer denotes one for which a substituent group, a methyl group, for example, replaces a hydrogen on the polymer backbone.

As used herein “oxidation-resistant” refers to a separator that resists oxidation in an electrochemical cell of an alkaline battery and/or is substantially stable in the presence of an alkaline electrolyte and/or an oxidizing agent (e.g., silver ions).

As used herein, “adjacent” refers to the positions of at least two distinct elements (e.g., at least one separator and at least one electrode (e.g., an anode and/or a cathode)). When an element such as a separator is adjacent to another element such as an electrode or even a second separator, one element is positioned to contact or nearly contact another element. For example, when a separator is adjacent to an electrode, the separator electrically contacts the electrode when the separator and electrode are in an electrolyte environment such as the environment inside an electrochemical cell. The separator can be in physical contact or the separator can nearly contact the electrode such that any space between the separator and the electrode is void of any other separators or electrodes. It is noted that electrolyte can be present in any space between a separator that is adjacent to an electrode or another separator.

As used herein, “unitary structure” refers to a structure that includes one or more elements that are concurrently or almost concurrently processed to form the structure. For example, a multilayered separator for use in an alkaline electrochemical cell that is a unitary structure can include one in which all of the separator ingredients or starting materials concurrently undergo a process (other than mechanical combination) that combines them and forms a single separator. Such multilayered separators include, for example, those that comprise a plurality of layers, which are formed by co-extruding starting materials from a plurality of sources to generate a wet co-extrusion that is sufficiently dried or irradiated such that at least two of the layers of the co-extrusion are independently cross-linked and/or cross-linked together. This unitary structure is not equivalent to a separator that includes a plurality of layers that are each individually formed and mechanically stacked to form a multi-layered separator.

As used herein “dendrite-resistant” refers to a separator that reduces the formation of dendrites in an electrochemical cell of an alkaline battery under normal operating conditions, i.e., when the batteries are stored and used in temperatures from about −20° C. to about 70° C., and are not overcharged or charged above their rated capacity and/or is substantially stable in the presence of an alkaline electrolyte, and/or is substantially stable in the presence of a reducing agent (e.g., an anode comprising zinc). In some examples, a dendrite-resistant separator inhibits transport and/or chemical reduction of metal ions.

As used herein, “quaternary ammonium” and “QA” are used interchangeably to refer to polymers having a quaternary nitrogen atom in the polymer backbone or in the polymer side chain.

As used herein, “quaternary phosphonium” and “QP” are used interchangeably to refer to polymers having a phosphorous atom in the polymer backbone or in the polymer side chain, wherein the phosphorous atom is bonded, via a single bond or a double bond, to 4 separate moieties wherein each of the moieties are different, or 2 or more are the same group. Some exemplary QP polymer materials include one or more monomers comprising a phosphonate ester. Polymers comprising monomers comprising QP moieties may also include co-polymers that include sulfonate esters.

### II. SEPARATORS

One aspect of the present invention provides a separator for use in an electrochemical cell, wherein the separator comprises one or more layers, and wherein at least one layer comprises a polymer material. In some multi-layer co-extruded composite separators of the present invention, quaternary ammonium and sulfonic acid groups have been used as substituents on polymer backbones to impart chemical resistance, ion selectivity, or chemical resistance properties to the separator. Another class of substituents useful in separators of the present invention includes phosphorous or phosphorous oxide containing polymers. Many members of these polymers have been shown to possess high ionic conductivity for hydroxide ions and or protons. Polymers that possess high conductivity for hydroxide and/or protons would be most useful in co-extruded separators as one or more of the layers.

A. Quaternary Ammonium Polymers

One aspect of the present invention provides a separator for use in an alkaline electrochemical cell comprising a QA polymer, wherein the separator is substantially resistant to oxidation by silver oxide. The QA polymer can comprise a QA homopolymer or a QA co-polymer. For example, the QA polymer comprises a QA homopolymer. In other examples, the QA polymer comprises a co-polymer. And, in alternative embodiments, the QA polymer comprises poly[(2-ethyldimethylammonioethyl methacrylate ethyl sulfate)-co-(1-vinylpyrrolidone)], a homopolymer of poly(2-dimethylamino)ethyl methacrylate) methyl chloride quaternary salt, poly(acrylamide-co-diallyldimethylammonium chloride), homopolymer of Polymer 3: poly(diallyldimethylammonium chloride), poly(dimethylamine-co-epichlorohydrin-co-ethylenediamine) or mixtures thereof.

QA polymers useful in the present invention can optionally include additives such as surfactants, fillers, colorants, or other additives that improve one or more properties of the QA polymer. For example, the QA polymer comprises a filler. In other examples, the QA polymer comprises a filler comprising a metal oxide powder, a silicate powder, or a combination thereof. For example, the filler comprises a powder of zirconium oxide, titanium oxide, aluminum oxide, silicon oxide, aluminosilicate, calcium oxide, magnesium oxide, strontium oxide, barium oxide, or any combination thereof. In another example, the filler comprises zirconium oxide powder.

In another embodiment of the present invention, the separator comprises a plurality of layers (i.e., a multi-layered separator), wherein at least one of the layers comprises a quaternary polymer material (e.g., a QP material or QA material) or a PSA material as described above. In another embodiment of the present invention, the separator comprises a plurality of layers (i.e., a multi-layered separator), wherein at least one of the layers comprises a quaternary polymer material (e.g., a QP material or QA material) as described above. In these separators, the layer that comprises the QA polymer can be an external layer, i.e., a layer in which one face of the layer is adjacent to an electrode absent any intervening separator layers, or an internal layer, i.e., a layer in which 2 faces of the layer are adjacent to 2 distinct separator layers.

In several embodiments, the separator comprises a first layer comprising a QA polymer and a second layer comprising a second polymer material. Useful second polymer materials include polymers (e.g., homopolymers and/or co-polymers) that are substantially stable in an alkaline environment such as that of an electrochemical cell. Exemplary second polymer materials include homopolymers and co-polymers of PEO, PPO, PVA, or any combination thereof.

In one example, the second polymer material comprises a PVA polymer. For instance, the PVA polymer comprises a PVA homopolymer, a PVA co-polymer, or a mixture of PVA homopolymer or PVA co-polymer and another polymer or co-polymer. In some embodiments, the PVA polymer further comprises PVA that is at least about 70% hydrolyzed. In other embodiments, the PVA polymer material further comprises PVA having an average molecular weight of at least about 80,000 amu.

In other embodiments, the PVA polymer material comprises a PVA co-polymer. For example, the PVA co-polymer comprises polyvinyl alcohol-co-polyvinylsulfonic acid. For instance, the PVA co-polymer further comprises polyvinyl alcohol-co-polystyrene sulfonic acid. In another instance, the PVA co-polymer further comprises polyvinyl alcohol-co-polystyrene sulfonic acid, and the polyvinyl alcohol is present in a concentration of at from about 10 wt % to about 60 wt % by weight of the co-polymer.

In several embodiments, the PVA polymer material comprises a mixture of PVA homopolymer or PVA co-polymer and at least one additional homopolymer or co-polymer. For example, the PVA polymer material further comprises a mixture of PVA homopolymer and polyvinylsulfonic acid, polyacrylic acid, acrylic acid co-polymer, polyacrylamide, acrylamide co-polymer, polyvinyl amine, vinyl amine co-polymer, maleic acid co-polymer, maleic anhydride co-polymer, polyvinyl ether, vinyl ether co-polymer, polyethylene glycol, ethylene glycol co-polymer, polypropylene glycol, polypropylene glycol co-polymer, sulfonated polysulfone, sulfonated polyethersulfone, sulfonated polyetheretherketone, polyallyl ether, polydivinylbenzene, or triallyltriazine. In other embodiments, the PVA polymer material further comprises a PVA homopolymer.

In several embodiments, the separator comprises more that 2 layers, wherein at least 1 of the 2 layers comprises a QA polymer. For example, in addition to the separators described above, the separator also comprises a third polymer material that comprises a third polymer material. The third polymer material can comprise a PVA polymer material or other polymer material.

In multi-layered separators of the present invention, one or more of the layers can be cross-linked to one or more other layers. For example, in embodiments where the separator comprises a plurality of layers and one of which comprises QA polymer, the QA polymer and one or more of the other layers may be cross-linked together. Cross-linking of separator layers may be accomplished by irradiating the layers, using a cross-linking agent such as boric acid, or using other methods.

The separators of the present invention can be used with any battery, comprising any electrolyte, any anode and/or any cathode. The invention is especially suitable for use in an alkaline storage battery comprising a zinc anode and a silver oxide cathode but can be used with other anodes and other cathodes. For instance, a multilayered separator of the present invention can be used with anodes comprising zinc, cadmium or mercury, or mixtures thereof, for example, and with cathodes comprising silver oxide (e.g., AgO, Ag₂O, Ag₂O₃, or any combination thereof), nickel oxide, cobalt oxide or manganese oxide, or mixtures thereof, for example.

It is noted that multilayered battery separators of the present invention can be configured in any suitable way such that the separator is substantially inert in the presence of the anode, cathode and electrolyte of the electrochemical cell. For example, a multilayered separator for a rectangular battery electrode can be in the form of a sheet or film comparable in size or slightly larger than the electrode, and can simply be placed on the electrode or can be sealed around the edges. The edges of the separator can be sealed to the electrode, an electrode current collector, a battery case, or another separator sheet or film on the backside of the electrode via an adhesive sealant, a gasket, or fusion (heat sealing) of the separator or another material. The separator can also be in the form of a sheet or film wrapped and folded around the electrode to form a single layer (front and back), an overlapping layer, or multiple layers. For a cylindrical battery, the separator can be spirally wound with the electrodes in a jelly-roll configuration. Typically, the separator is included in an electrode stack comprising a plurality of separators. The oxidation-resistant separator of the invention can be incorporated in a battery in any suitable configuration.

In addition to a first active layer comprising a QA polymer material, such as those described herein, and a second active layer comprising a PVA polymer material, such as those described herein, separators of the present invention can also include additional layers comprising polymer materials such as one or more PEO layers, one or more additional PVA layers, one or more PSA layers, or any combination thereof. For example, a multilayered separator comprises a first active layer comprising a first QA polymer material and a second active layer comprising PSA, and third layer comprising a second PVA polymer material. In another example, a multilayered separator comprises a first active layer comprising a first PVA polymer material that comprises a PVA co-polymer (e.g., polyvinyl alcohol-co-polyvinyl sulfonic acid (e.g., polyvinyl alcohol-co-polystyrene sulfonic acid)), a second active layer comprising a PSA polymer material (e.g., polystyrene sulfonic acid homopolymer), and a third layer comprising a second PVA polymer material that comprises PVA homopolymer, wherein at least the first active layer is cross-linked to the second active are cross-linked.

It is noted that in multilayered separators of the present invention, the layers, i.e., the first active layer, the second active layer, the third active layer, or the like, can be stacked in any order.

In several embodiments, the separator of the present invention comprises a first active layer comprising a QA polymer material and a second active layer comprising a PVA polymer material, wherein the first active layer and the second active layer are independently cross-linked to form a unitary structure that is substantially resistant to oxidation by silver oxide. For example, the first active layer and the second active layer can be independently cross-linked concurrently, i.e., in a single step or process (e.g., heating both active layers together or irradiating both active layers together) wherein both active layers are simultaneously or almost simultaneously independently cross-linked, or separately, i.e., in separate processes (e.g., cross-linking the first active layer to form film, depositing the second active layer onto the first active layer, and heating the layers such that the second active layer is cross-linked), wherein each active layer is independently cross-linked in a separate process.

In several multi-layered separators of the present invention comprising more than two active layers, at least two active layers are independently cross-linked.

In other embodiments, the multi-layered separator of the present invention comprises a first active layer comprising a PVA polymer material and a second active layer comprising a PSA polymer material, wherein the first active layer and the second active layer are independently cross-linked, and the first active layer is cross-linked with the second active layer to form a unitary structure that is substantially resistant to oxidation by silver oxide.

Several separators of the present invention optionally include a PVA active layer or a PSA active layer in addition to an active layer comprising QA polymer.

B. Quaternary Phosphonium Polymers

One aspect of the present invention provides a separator for use in an alkaline electrochemical cell comprising a QP polymer, wherein the separator is substantially resistant to oxidation by silver oxide. The QP polymer can comprise a QP homopolymer or a QP co-polymer. For example, the QP polymer material comprises a QP homopolymer. In other examples, the QP polymer comprises a co-polymer. Specific examples of QP polymer materials include co-polymers containing one or more phosphine oxide monomer units and co-polymers containing one or more phosphonium monomer units.

In some embodiments, the QP polymer material includes a monomer of Formula (B):

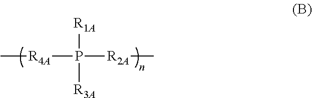

wherein n is the number of monomers present in the polymer; each of R_{1A}, and R_{3A} is independently ═O, —OH, or aryl, heteroaryl, —O-alkyl or alkyl (e.g., C₁₋₆ alkyl), wherein any of the aryl, heteroaryl, or alkyl groups is optionally substituted; R_{2A} and R_{4A} are each independently optionally substituted aryl, optionally substituted heteroaryl, optionally substituted alkoxy, optionally substituted alkyl, or R_{1A} and one of R_{2A}, R_{3A}, or R_{4A} taken together with the phosphorous atom to which they are attached form an optionally substituted heterocyclic ring.

In alternative embodiments, the QP polymer materials include poly(arylene phenyl phosphineoxide ether sulfone terpolymers, quaternary alkyl phosphonium halide salts having the Formula C

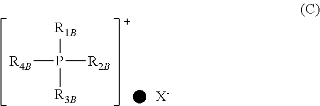

wherein each of R_{1B}, R_{2B}, R_{3B}, and R_{4B} is independently an optionally substituted alkylidene chain that is optionally interrupted by one or more —O— groups, an optionally substituted arylene chain that is optionally interrupted by one or more —O— groups, or R_{1B} and one of R_{2B}, R_{3B}, or R_{4B} taken together with the phosphorous atom to which they are attached form an optionally substituted 5-8 membered heterocycle; and X is an anion such as a halide anion (Cl⁻, Br⁻, F⁻, or I⁻) or a polyatomic anion. Other QP polymer materials include poly phosphine oxide (e.g., poly(arylene phosphine oxide)) and the like. These QP polymer materials also include co-polymers such as block co-polymers, alternating co-polymers, periodic co-polymers, and the like, or any combination thereof. An example of a QP polymer material includes a polymer comprising the following monomer

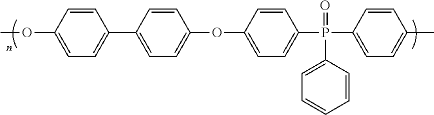

wherein n is the number of monomer units present in the polymer. Such-QP polymer materials can additional comprise block co-polymers such as

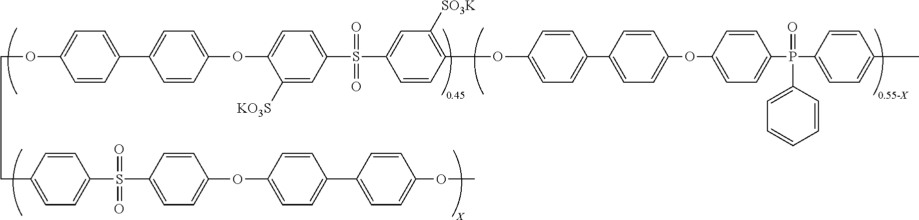

QP polymers useful in the present invention can optionally include additives such as surfactants, fillers, colorants, or other additives that improve one or more properties of the QP polymer. For example, the QP polymer comprises a filler. In other examples, the QP polymer comprises a filler comprising a metal oxide powder, a silicate powder, or a combination thereof. For example, the filler comprises a powder of zirconium oxide, titanium oxide, aluminum oxide, silicon oxide, aluminosilicate, calcium oxide, magnesium oxide, strontium oxide, barium oxide, or any combination thereof. In another example, the filler comprises zirconium oxide powder.

In another embodiment of the present invention, the separator comprises a plurality of layers (i.e., a multi-layered separator), wherein at least one of the layers comprises a QP polymer as described above. In these separators, the layer that comprises the QP polymer can be an external layer, i.e., a layer in which one face of the layer is adjacent to an electrode absent any intervening separator layers, or an internal layer, i.e., a layer in which 2 faces of the layer are adjacent to 2 distinct separator layers.

In several embodiments, the separator comprises a first layer comprising a QP polymer and a second layer comprising a second polymer material. Useful second polymer materials include polymers (e.g., homopolymers and/or co-polymers) that are substantially stable in an alkaline environment such as that of an electrochemical cell. Exemplary second polymer materials include homopolymers and co-polymers of PEO, PPO, PVA, or any combination thereof.

In one example, the second polymer material comprises a PVA polymer. For instance, the PVA polymer comprises a PVA homopolymer, a PVA co-polymer, or a mixture of PVA homopolymer or PVA co-polymer and another polymer or co-polymer. In some embodiments, the PVA polymer further comprises PVA that is at least about 70% hydrolyzed. In other embodiments, the PVA polymer material further comprises PVA having an average molecular weight of at least about 80,000 amu.

In other embodiments, the PVA polymer material comprises a PVA co-polymer. For example, the PVA co-polymer comprises polyvinyl alcohol-co-polyvinylsulfonic acid. For instance, the PVA co-polymer further comprises polyvinyl alcohol-co-polystyrene sulfonic acid. In another instance, the PVA co-polymer further comprises polyvinyl alcohol-co-polystyrene sulfonic acid, and the polyvinyl alcohol is present in a concentration of at from about 10 wt % to about 60 wt % by weight of the co-polymer.

In several embodiments, the PVA polymer material comprises a mixture of PVA homopolymer or PVA co-polymer and at least one additional homopolymer or co-polymer. For example, the PVA polymer material further comprises a mixture of PVA homopolymer and polyvinylsulfonic acid, polyacrylic acid, acrylic acid co-polymer, polyacrylamide, acrylamide co-polymer, polyvinyl amine, vinyl amine co-polymer, maleic acid co-polymer, maleic anhydride co-polymer, polyvinyl ether, vinyl ether co-polymer, polyethylene glycol, ethylene glycol co-polymer, polypropylene glycol, polypropylene glycol co-polymer, sulfonated polysulfone, sulfonated polyethersulfone, sulfonated polyetheretherketone, polyallyl ether, polydivinylbenzene, or triallyltriazine. In other embodiments, the PVA polymer material further comprises a PVA homopolymer.

In several embodiments, the separator comprises more that 2 layers, wherein at least 1 of the 2 layers comprises a QP polymer. For example, in addition to the separators described above, the separator also comprises a third polymer material that comprises a third polymer material. The third polymer material can comprise a PVA polymer material or other polymer material.

In multi-layered separators of the present invention, one or more of the layers can be cross-linked to one or more other layers. For example, in embodiments where the separator comprises a plurality of layers and one of which comprises QP polymer, the QP polymer and one or more of the other layers may be cross-linked together. Cross-linking of separator layers may be accomplished by irradiating the layers, using a cross-linking agent such as boric acid, or using other methods.

The separators of the present invention can be used with any battery, comprising any electrolyte, any anode and/or any cathode. The invention is especially suitable for use in an alkaline storage battery comprising a zinc anode and a silver oxide cathode but can be used with other anodes and other cathodes. For instance, a multilayered separator of the present invention can be used with anodes comprising zinc, cadmium or mercury, or mixtures thereof, for example, and with cathodes comprising silver oxide (e.g., AgO, Ag₂O, Ag₂O₃, or any combination thereof), nickel oxide, cobalt oxide or manganese oxide, or mixtures thereof, for example.

It is noted that multilayered battery separators of the present invention can be configured in any suitable way such that the separator is substantially inert in the presence of the anode, cathode and electrolyte of the electrochemical cell. For example, a multilayered separator for a rectangular battery electrode can be in the form of a sheet or film comparable in size or slightly larger than the electrode, and can simply be placed on the electrode or can be sealed around the edges. The edges of the separator can be sealed to the electrode, an electrode current collector, a battery case, or another separator sheet or film on the backside of the electrode via an adhesive sealant, a gasket, or fusion (heat sealing) of the separator or another material. The separator can also be in the form of a sheet or film wrapped and folded around the electrode to form a single layer (front and back), an overlapping layer, or multiple layers. For a cylindrical battery, the separator can be spirally wound with the electrodes in a jelly-roll configuration. Typically, the separator is included in an electrode stack comprising a plurality of separators. The oxidation-resistant separator of the invention can be incorporated in a battery in any suitable configuration.

In addition to a first active layer comprising a QP polymer material, such as those described herein, and a second active layer comprising a PVA polymer material, such as those described herein, separators of the present invention can also include additional layers comprising polymer materials such as one or more PEO layers, one or more additional PVA layers, one or more PSA layers, or any combination thereof. For example, a multilayered separator comprises a first active layer comprising a first QP polymer material and a second active layer comprising PSA, and third layer comprising a second PVA polymer material. In another example, a multilayered separator comprises a first active layer comprising a first PVA polymer material that comprises a PVA co-polymer (e.g., polyvinyl alcohol-co-polyvinyl sulfonic acid (e.g., polyvinyl alcohol-co-polystyrene sulfonic acid)), a second active layer comprising a PSA polymer material (e.g., polystyrene sulfonic acid homopolymer), and a third layer comprising a second PVA polymer material that comprises PVA homopolymer, wherein at least the first active layer is cross-linked to the second active are cross-linked.

It is noted that in multilayered separators of the present invention, the layers, i.e., the first active layer, the second active layer, the third active layer, or the like, can be stacked in any order.

In several embodiments, the separator of the present invention comprises a first active layer comprising a QP polymer material and a second active layer comprising a PVA polymer material, wherein the first active layer and the second active layer are independently cross-linked to form a unitary structure that is substantially resistant to oxidation by silver oxide. For example, the first active layer and the second active layer can be independently cross-linked concurrently, i.e., in a single step or process (e.g., heating both active layers together or irradiating both active layers together) wherein both active layers are simultaneously or almost simultaneously independently cross-linked, or separately, i.e., in separate processes (e.g., cross-linking the first active layer to form film, depositing the second active layer onto the first active layer, and heating the layers such that the second active layer is cross-linked), wherein each active layer is independently cross-linked in a separate process.

In several multi-layered separators of the present invention comprising more than two active layers, at least two active layers are independently cross-linked.

In other embodiments, the multi-layered separator of the present invention comprises a first active layer comprising a PVA polymer material and a second active layer comprising a PSA polymer material, wherein the first active layer and the second active layer are independently cross-linked, and the first active layer is cross-linked with the second active layer to form a unitary structure that is substantially resistant to oxidation by silver oxide.

Several separators of the present invention optionally include a PVA active layer or a PSA active layer in addition to an active layer comprising QP polymer.

C. Polyvinyl Alcohol Active Layer

One active layer of a separator of the present invention comprises a PVA polymer material. The PVA polymer material comprises PVA, which can be present as a PVA homopolymer, a PVA co-polymer (e.g., a block co-polymer, a random co-polymer, an alternating co-polymer, or the like), or a mixture of PVA homopolymer or a PVA co-polymer and another polymer or co-polymer (e.g., polyvinyl alcohol-co-vinyl sulfonic acid).

In several embodiments, the PVA polymer material comprises PVA that is at least about 70% (e.g., at least about 75% or at least about 80%) hydrolyzed. For example, the PVA polymer material comprises PVA that is about 99% hydrolyzed. In other embodiments, the PVA polymer material comprises PVA having an average molecular weight of greater than about 35,000 amu (e.g., from about 40,000 amu to about 190,000 amu). For instance the PVA polymer material comprises PVA having an average molecular weight of greater than about 80,000 amu (e.g., greater than 90,000 amu, greater than 100,000 amu, greater than about 120,000 amu, or from 140,000 amu to 190,000 amu). In some embodiments, the PVA polymer material comprises PVA that is at least about 70% hydrolyzed and has an average molecular weight of greater than about 100,000 amu. For instance the PVA polymer material comprises PVA that is about 99% hydrolyzed and has an average molecular weight of from about 140,000 amu to about 190,000 amu.

In several embodiments, the PVA polymer material comprises a PVA co-polymer (e.g., a block co-polymer, a random co-polymer, an alternating co-polymer, or the like). For example, the PVA co-polymer comprises a random co-polymer. In another example, the PVA co-polymer comprises a random co-polymer comprising PVA or vinyl alcohol monomer, and at least one other polymer or monomer. In some instances, the PVA co-polymer comprises at least 50 mole percent (e.g., from about 50 mole percent to about 90 mole percent) of PVA or vinyl alcohol monomer. For example, the PVA polymer material comprises a PVA co-polymer, and the PVA co-polymer comprises PVA or vinyl alcohol monomer and a hydroxyl conducting monomer. Suitable hydroxyl-conducting monomers have functional groups that facilitate migration of hydroxyl ions. Exemplary hydroxyl-conducting monomer include acrylates, lactones, sulfonates, carboxylates, sulfates, sarconates, amides, amidosulfonate, any combination thereof, or the like. A solution containing a co-polymer of a polyvinyl alcohol and a polylactone is sold commercially under the trade name Vytek® polymer by Celanese, Inc. In several examples, the PVA co-polymer comprises from about 1 wt % to about 10 wt % of a hydroxyl conducting monomer by weight of the co-polymer.

In another example, the PVA polymer material comprises a PVA co-polymer, and the PVA co-polymer comprises polyvinyl alcohol-co-vinylsulfonic acid (PVA-co-PSA). For instance, the PVA polymer material comprises a PVA co-polymer, and the PVA co-polymer comprises polyvinyl alcohol-co-polyvinylsulfonic acid, wherein the co-polymer further comprises from about 10 wt % to about 60 wt % (e.g., from about 10 wt % to about 50 wt % or from about 20 wt % to about 50 wt %) of PVA by weight of the co-polymer.

In several embodiments, the PVA polymer material comprises a mixture of PVA or a PVA co-polymer and at least one additional polymer or co-polymer. For example, the PVA polymer material comprises a mixture of PVA and polyvinylsulfonic acid, (e.g., polystyrene sulfonic acid), polyacrylic acid (e.g., polymethylacrylic acid, acrylic acid grafted fluorinated polymer, or the like), acrylic acid co-polymer, polyacrylamide, acrylamide co-polymer, polyvinyl amine, vinyl amine co-polymer, maleic acid co-polymer, maleic anhydride co-polymer, polyvinyl ether, vinyl ether co-polymer, polyethylene glycol, ethylene glycol co-polymer, polypropylene glycol, polypropylene glycol co-polymer, sulfonated polysulfone, sulfonated polyethersulfone, sulfonated polyetheretherketone, polyallyl ether (e.g., polyvinyl ether), polydivinylbenzene, or triallyltriazine.

In one embodiment, the PVA polymer material comprises PVA homopolymer.

In other embodiments, the PVA polymer material comprises internally cross-linked PVA. For example, the PVA polymer material comprises PVA homopolymer that is internally cross-linked or a PVA co-polymer that is internally cross-linked. For example, the PVA polymer material comprises an internally cross-linked PVA co-polymer (e.g., PVA-co-PSA (e.g., polyvinyl alcohol-co-polystyrene sulfonic acid).

PVA polymer material can also comprise one or more optional additives such as cross-linking agents, surfactants, plasticizers, fillers, combinations thereof, or the like.

In several embodiments, the PVA material comprises an optional cross-linking agent in a sufficient quantity as to render the PVA active layer substantially insoluble in aqueous solvents. Exemplary cross-linking agents include, without limitations, monoaldehydes (e.g., formaldehyde or glyoxilic acid); aliphatic, furyl or aryl dialdehydes (e.g., glutaraldehyde, 2,6 furyldialdehyde or terephthaldehyde); dicarboxylic acids (e.g., oxalic acid or succinic acid); polyisocyanates; methylolmelamine; co-polymers of styrene and maleic anhydride; germaic acid and its salts; boron compounds (e.g., boron oxide, boric acid or its salts; or metaboric acid or its salts); or salts of copper, zinc, aluminum or titanium.

In other embodiments, the PVA material is substantially free of cross-linking agents.

In one embodiment, the PVA material optionally comprises a filler. Suitable fillers are substantially insolvent in aqueous solvents. Exemplary fillers include, without limitation, metal oxide powders, silicate powders, or a combination thereof. Although not wishing to be limited by theory, it is theorized that the filler impedes the migration of ions (e.g., silver ions and zinc ions in zinc-silver oxide batteries) detrimental to the service life of a battery (e.g., a zinc-silver oxide battery). In several examples, the PVA polymer material comprises a filler, and the filler comprises a powder of zirconium oxide, titanium oxide, aluminum oxide, silicon oxide, aluminosilicate, calcium oxide, magnesium oxide, strontium oxide, barium oxide, or any combination thereof. In other examples, the PVA polymer material comprises zirconium oxide powder. For instance, the PVA polymer material comprises from about 5 wt % to about 50 wt % (e.g., from about 10 wt % to about 40 wt %, from about 15 wt % to about 35 wt %, or from about 20 wt % to about 30 wt %) of zirconium oxide powder by weight of the PVA polymer material.

In another example, the PVA polymer material comprises zirconium oxide powder and PVA co-polymer comprising polyvinyl alcohol-co-polyvinylsulfonic acid. For instance, the PVA polymer material comprises from about 5 wt % to about 50 wt % of zirconium oxide powder and a PVA co-polymer comprising polyvinyl alcohol-co-polyvinylsulfonic acid, wherein the PVA in the co-polymer has a concentration of from about 10 wt % to about 40 wt % by weight of the PVA co-polymer.

In other embodiments, the PVA polymer material further comprises a surfactant. Suitable surfactants include anionic surfactants, cationic surfactants, nonionic surfactants, ampholytic surfactants, amphoteric surfactants, and zwitterionic surfactants. In several examples, the PVA polymer material comprises from about 0.01 wt % to about 1 wt % of surfactant by weight of the PVA polymer material.

In several embodiments, the PVA polymer material further comprises a plasticizer. Exemplary plasticizers include glycerin, low-molecular-weight polyethylene glycol, aminoalcohol, polypropylene glycols, 1,3 pentanediol branched analogs, 1,3 pentanediol, water, or any combination thereof. For example, the plasticizer comprises glycerin, a low-molecular-weight polyethylene glycol, an aminoalcohol, a polypropylene glycols, a 1,3 pentanediol branched analog, 1,3 pentanediol, or combinations thereof, and/or water. In some examples, the plasticizer comprises greater than about 1 wt % of glycerin, low-molecular-weight polyethylene glycols, aminoalcohols, polypropylene glycols, 1,3 pentanediol branched analogs, 1,3 pentanediol, or any combination thereof, and less than 99 wt % of water by weight of the plasticizer. In other examples, the plasticizer comprises from about 1 wt % to about 10 wt % of glycerin, low-molecular-weight polyethylene glycols, aminoalcohols, polypropylene glycols, 1,3 pentanediol branched analogs, 1,3 pentanediol, or any combination thereof, and from about 99 wt % to about 90 wt % of water by weight of the plasticizer.

D. Polysulfonic Acid Active Layer

Another active layer of a separator of the present invention comprises a PSA polymer material. The PSA polymer material comprises PSA, which can be present as a PSA homopolymer, a PSA co-polymer (e.g., a block co-polymer, a random co-polymer, an alternating co-polymer, or the like), or a mixture of PSA homopolymer or a PSA co-polymer and another polymer or co-polymer.

In several embodiments, the PSA polymer material comprises a mixture of PSA (e.g., polystyrene sulfonic acid or other polysulfonic acid of Formula A) homopolymer or a PSA co-polymer and another polymer or co-polymer. For example, the PSA polymer material comprises a mixture of PSA (e.g., polystyrene sulfonic acid or other polysulfonic acid of Formula A) and polyacrylic acid (e.g., polymethylacrylic acid, acrylic acid grafted fluorinated polymer, or the like), acrylic acid co-polymer, polyacrylamide, acrylamide co-polymer, polyvinyl amine, vinyl amine co-polymer, maleic acid co-polymer, maleic anhydride co-polymer, polyvinyl ether, vinyl ether co-polymer, polyethylene glycol, ethylene glycol co-polymer, polypropylene glycol, polypropylene glycol co-polymer, sulfonated polysulfone, sulfonated polyethersulfone, sulfonated polyetheretherketone, polyallyl ether (e.g., polyvinyl ether), polydivinylbenzene, or triallyltriazine. In another example, the PSA polymer material comprises a co-polymer comprising a polystyrene sulfonic acid or other polysulfonic acid of Formula A and a polyacrylic acid (e.g., polymethylacrylic acid, acrylic acid grafted fluorinated polymer, or the like), acrylic acid co-polymer, polyacrylamide, acrylamide co-polymer, polyvinyl amine, vinyl amine co-polymer, maleic acid co-polymer, maleic anhydride co-polymer, polyvinyl ether, vinyl ether co-polymer, polyethylene glycol, ethylene glycol co-polymer, polypropylene glycol, polypropylene glycol co-polymer, sulfonated polysulfone, sulfonated polyethersulfone, sulfonated polyetheretherketone, polyallyl ether (e.g., polyvinyl ether), polydivinylbenzene, or triallyltriazine.

In other embodiments, the PSA polymer material comprises polystyrene sulfonic acid homopolymer.

PSA polymer material can also comprise one or more optional additives such as surfactants, plasticizers, fillers, combinations thereof, or the like, such as those described above.

E. Additional Materials

Multilayered separators of the present invention can optionally comprise additional materials such as a substrate. Substrates suitable for use in separators of the present invention include woven or non-woven substrates that are compatible with the QP polymer or other polymers if the separator is a multi-layered separator. Also, many substrates useful in the present invention are substantially inert under separator processing conditions (e.g., heat drying, irradiation, the like, or any combination thereof). In some instances, the substrate comprises a woven or non-woven material.

In one embodiment, a multilayered separator of the present invention comprises a first active layer comprising a QP polymer material, a second active layer comprising a PSA polymer material, and a non-woven substrate comprising a hydrophilic polyolefin, wherein the first active layer and the second active layer are provided to form a unitary structure that is substantially resistant to oxidation by silver oxide.

In another embodiment, a multilayered separator of the present invention comprises a first active layer comprising a QP polymer material, a second active layer comprising a PSA or PVA polymer material, and a non-woven substrate comprising a polyamide, wherein the first active layer and the second active layer are provided to form a unitary structure that is substantially resistant to oxidation by silver oxide.

In one embodiment, a multilayered separator of the present invention comprises a first active layer comprising a QP polymer material, a second active layer comprising a PSA or PVA polymer material, and a substrate comprising polyester, wherein the first active layer and the second active layer are provided to form a unitary structure that is substantially resistant to oxidation by silver oxide.

### III. METHODS OF MANUFACTURING SEPARATORS

Another aspect of the present invention provides a method of manufacturing a separator comprising providing a QP polymer, wherein the separator is substantially resistant to oxidation by silver oxide. QP polymers useful in the methods of the present invention include any QP polymer described above.

Several methods of the present invention also include providing a plurality of additional polymer materials. For example, these additional polymers can be provided as distinct layers or as mixtures of polymers, which generate a single layer. Exemplary additional polymers useful in the methods of the present invention include any of the polymers described herein.

In one embodiment, the method includes providing a first active layer comprising a QP polymer material and providing a second active layer comprising a PSA or PVA polymer material, wherein the first active layer and the second active layer are provided to form a unitary structure.

In one embodiment, a method of producing a multilayered separator comprises providing a first active layer comprising a QP polymer material, providing a second active layer comprising a PSA or PVA polymer material, and independently cross-linking the first active layer and the second active layer to form a unitary structure.

As noted above, the first active layer and the second active layer can be independently cross-linked concurrently, i.e., in a single step or process (e.g., heating both active layers together or irradiating both active layers together) wherein both active layers are simultaneously or almost simultaneously independently cross-linked, or separately, i.e., in separate processes (e.g., cross-linking the first active layer to form film, depositing the second active layer onto the first active layer, and heating the layers such that the second active layer is cross-linked), wherein each active layer is independently cross-linked in a separate process.

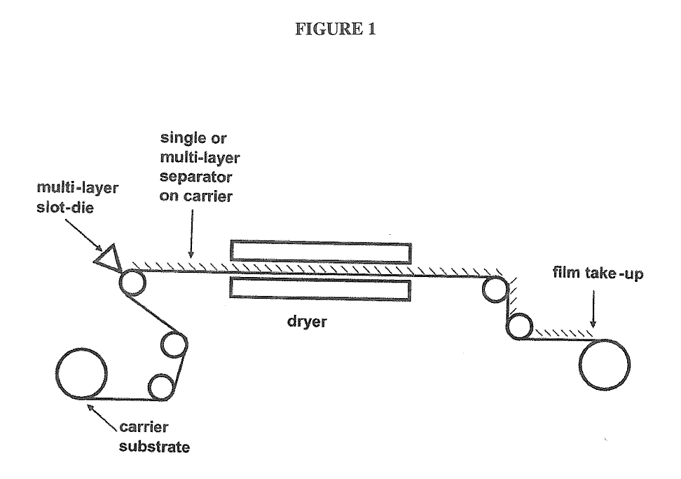

In another embodiment, illustrated in FIG. 1, a method of producing a multilayered separator comprises co-extruding at least a first active layer comprising QP polymer material and a second active layer comprising a PVA or PSA polymer material through a slotted die onto a carrier (e.g., a substrate-lined carrier) and drying (e.g., heat drying, vacuum drying, or any combination thereof) the wet multilayered co-extrusion so that the active layers are independently cross-linked.

The methods of the present invention can optionally include providing a substrate film (e.g., a porous or nonporous substrate film), on which at least one of the active separator layers is deposited. In this case, the multi-functional separator can comprise a multiplex film on one side of a porous substrate, or separate films or multiplex films on opposite sides of a porous substrate.

In other embodiments, the method of producing a multilayered separator further comprises providing substrate. Substrates suitable for the methods of the present invention include woven and non-woven substrates, such as those described above. For instance, the method of producing a multilayered separator further comprises providing a substrate comprising a hydrophilic non-woven polyolefin (e.g., polyethylene). In another instance, the method of producing a multilayered separator further comprises providing a substrate comprising a non-woven polyamide (e.g., nylon). In still another instance, the method of producing a multilayered separator further comprises providing a substrate comprising polyester.

When present, a substrate can be provided in any suitable manner. For example, the substrate can be provided in a cast or on a carrier (e.g., a substrate-lined carrier).

In methods of the present invention, the polymer materials can be provided in any suitable manner. For example, polymer materials can be coextruded, a cascade coating method can be used, or the polymers can be provided using both coextrusion and cascade coating methods.

### IV. ELECTROCHEMICAL CELLS

Another aspect of the present invention provides an electrochemical cell comprising a cathode comprising silver oxide, an anode comprising zinc, an alkaline electrolyte, and a separator such as any of those described above.

In several embodiments, the electrochemical cell comprises a cathode comprising silver oxide, an anode comprising zinc, an alkaline electrolyte, and a separator comprising a QP polymer material.

In several examples, the alkaline electrolyte comprises a mixture of aqueous NaOH and aqueous KOH.

### Other Embodiments

All publications and patents referred to in this disclosure are incorporated herein by reference to the same extent as if each individual publication or patent application were specifically and individually indicated to be incorporated by reference. Should the meaning of the terms in any of the patents or publications incorporated by reference conflict with the meaning of the terms used in this disclosure, the meaning of the terms in this disclosure are intended to be controlling. Furthermore, the foregoing discussion discloses and describes merely exemplary embodiments of the present invention. One skilled in the art will readily recognize from such discussion and from the accompanying drawings and claims, that various changes, modifications and variations can be made therein without departing from the spirit and scope of the invention as defined in the following claims.

1. A multilayered separator for use in an alkaline electrochemical cell comprising:
a first active layer comprising a PVA polymer material; and
a second active layer comprising a quaternary polymer material or a PSA polymer material,
wherein the first active layer and the second active layer are provided to form a unitary structure that is substantially resistant to oxidation by silver oxide.

2. The separator of claim 1, wherein the second active layer comprises a quaternary polymer material comprising a QA polymer material.

3. The separator of claim 2, wherein the QA polymer material comprises a QA homopolymer or a QA co-polymer.

4. (canceled)

5. The separator of claim 3, wherein the QA polymer material comprises poly[(2-ethyldimethylammonioethyl methacrylate ethyl sulfate)-co-(1-vinylpyrrolidone)], poly((2-dimethylamino)ethyl methacrylate)methyl chloride quaternary salt, poly(acrylamide-co-diallyldimethylammonium chloride), poly(diallyldimethylammonium chloride), poly(dimethylamine-co-epichlorohydrin-co-ethylenediamine), or mixtures thereof.

6. The separator of claim 1, wherein the quaternary polymer material comprises a QP polymer material.

7. The separator of claim 6, wherein the QP polymer material comprises a homopolymer or a co-polymer.

8. (canceled)

9. The separator claim 7, wherein the QP polymer comprises a poly(arylene phenyl phosphineoxide ether sulfone) terpolymer.

10. The separator of claim 7, wherein the QP polymer comprises a quaternary alkyl phosphonium halide salt of Formula C 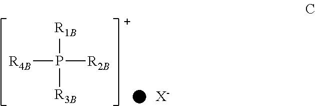
wherein each of R_{1B}, R_{2B}, R_{3B}, and R_{4B} is independently an optionally substituted alkylidene chain that is optionally interrupted by one or more —O— groups, an optionally substituted arylene chain that is optionally interrupted by one or more —O— groups, or R_{1B} and one of R_{2B}, R_{3B}, or R_{4B} taken together with the phosphorous atom to which they are attached form an optionally substituted 5-8 membered heterocycle; and X is a halide anion.

11. The separator claim 7, wherein the QP polymer comprises a polyphosphine oxide.

12. The separator of claim 11, wherein the QP polymer comprises a poly(arylene phosphine oxide).

13. The separator of claim 1, wherein the second active layer comprises a PSA polymer material.

14. The separator of claim 13, wherein the PSA polymer material further comprises a PSA homopolymer, a PSA co-polymer, or a mixture of PSA homopolymer or PSA co-polymer and another polymer or co-polymer.

15. The separator of claim 14, wherein the PSA polymer material comprises a polyvinyl sulfonic acid.

16. The separator of claim 14, wherein the PSA polymer material comprises a polystyrene sulfonic acid homopolymer.

17. The separator of claim 1, wherein the first active layer or the second active layer are independently cross-linked.

18. The separator of claim 1, wherein the first active layer further comprises a filler.

19. The separator of claim 18, wherein the filler comprises a metal oxide powder, a silicate powder, or a combination thereof.

20. The separator of claim 19, wherein the filler comprises a powder of zirconium oxide, titanium oxide, aluminum oxide, silicon oxide, aluminosilicate, calcium oxide, magnesium oxide, strontium oxide, barium oxide, or any combination thereof.

21. The separator of claim 20, wherein the filler comprises zirconium oxide powder.

22. The separator of claim 21, wherein the filler further comprises from about 5 wt % to about 50 wt % of zirconium oxide powder by weight of the PVA polymer material.

23. The separator of claim 1, wherein the PVA polymer material further comprises a PVA homopolymer, a PVA co-polymer, or a mixture of PVA homopolymer or PVA co-polymer and another polymer or co-polymer.

24. The separator of claim 23, wherein the PVA polymer material further comprises a PVA co-polymer.

25. The separator of claim 24, wherein the PVA co-polymer comprises polyvinyl alcohol-co-polyvinylsulfonic acid.

26. (canceled)

27. The separator of claim 25, wherein the PVA co-polymer further comprises polyvinyl alcohol-co-polystyrene sulfonic acid, and the polyvinyl alcohol is present in a concentration of at from about 10 wt % to about 60 wt % by weight of the co-polymer.

28. The separator of claim 1, wherein the PVA polymer material is at least about 70% hydrolyzed.

29. The separator of claim 1, wherein the PVA polymer material further comprises PVA having an average molecular weight of at least about 80,000 amu.

30. The separator of claim 1, wherein the PVA polymer material further comprises a mixture of PVA homopolymer or PVA co-polymer and at least one additional homopolymer or co-polymer.

31. The separator of claim 30, wherein the PVA polymer material further comprises a mixture of PVA homopolymer and polyvinylsulfonic acid, polyacrylic acid, acrylic acid co-polymer, polyacrylamide, acrylamide co-polymer, polyvinyl amine, vinyl amine co-polymer, maleic acid co-polymer, maleic anhydride co-polymer, polyvinyl ether, vinyl ether co-polymer, polyethylene glycol, ethylene glycol co-polymer, polypropylene glycol, polypropylene glycol co-polymer, sulfonated polysulfone, sulfonated polyethersulfone, sulfonated polyetheretherketone, polyallyl ether, polydivinylbenzene, triallyltriazine, or any combination thereof.

32. (canceled)

33. The separator of claim 1, wherein the second active layer further comprises a filler.

34. The separator of claim 33, wherein the filler comprises a metal oxide powder, a silicate powder, or a combination thereof.

35. The separator of claim 34, wherein the filler comprises a metal oxide powder.

36. The separator of claim 35, wherein the metal oxide powder comprises zirconium oxide, titanium oxide, aluminum oxide, silicon oxide, aluminosilicate, calcium oxide, magnesium oxide, strontium oxide, barium oxide, or any combination thereof

37. The separator of claim 36, wherein the filler comprises zirconium oxide powder.

38. The separator of claim 1, further comprising a third layer that comprises a second PVA polymer material.

39. The separator of claim 1, wherein the first active layer and the second active layer are cross-linked together.

40. A multilayered separator for use in an alkaline electrochemical cell comprising:
a first active layer comprising a first PVA polymer material;
a second active layer comprising a QA polymer material or a PSA polymer material; and
a third active layer comprising a second PVA polymer material,
wherein the first active layer and the second active layer are independently cross-linked to form a unitary structure that is substantially resistant to oxidation by silver oxide.

41. The separator of claim 40, wherein the second active layer comprises a QA polymer.

42. The separator of claim 41, wherein the QA polymer comprises a QA homopolymer or a QA co-polymer.

43. (canceled)

44. The separator of claim 42, wherein the QA polymer comprises poly[(2-ethyldimethylammonioethyl methacrylate ethyl sulfate)-co-(1-vinylpyrrolidone)], poly((2-dimethylamino)ethyl methacrylate)methyl chloride quaternary salt, poly(acrylamide-co-diallyldimethylammonium chloride), poly(diallyldimethylammonium chloride), poly(dimethylamine-co-epichlorohydrin-co-ethylenediamine), or mixtures thereof.

45. The separator of claim 40, wherein the second active layer comprises a PSA polymer.

46. The separator of claim 45, wherein the PSA polymer material further comprises a PSA homopolymer, a PSA co-polymer, or a mixture of PSA homopolymer or PSA co-polymer and another polymer or co-polymer.

47. The separator of claim 45, wherein the PSA polymer material comprises a polyvinyl sulfonic acid.

48. The separator of claim 47, wherein the PSA polymer material comprises a polystyrene sulfonic acid homopolymer.

49. The separator of claim 40, wherein the first PVA polymer material comprises a PVA co-polymer.

50. The separator of claim 49, wherein the first PVA polymer material comprises a co-polymer further comprising polyvinyl alcohol-co-polyvinylsulfonic acid.

51. The separator of claim 50, wherein the polyvinyl alcohol-co-polyvinylsulfonic acid is polyvinyl alcohol-co-polystyrene sulfonic acid.

52. The separator of claim 51, wherein the first PVA polymer material further comprises zirconium oxide.

53. The separator of claim 40, wherein the third active layer comprises a second PVA polymer material, and the second PVA polymer material comprises PVA homopolymer.

54. (canceled)

55. The separator of claim 53, wherein the PVA homopolymer is cross-linked to the first active layer, the second active layer, or both.

56. A multilayered separator for use in an alkaline electrochemical cell comprising:
a first active layer comprising a PVA-co-PSA and zirconium oxide powder;
a second active layer comprising PSA homopolymer; and
a third active layer comprising cross-linked PVA homopolymer,
wherein each of the first, second and third active layers are independently cross-linked.

57. (canceled)

58. (canceled)

59. (canceled)

60. (canceled)

61. (canceled)

62. (canceled)

63. A method of manufacturing a multilayered separator comprising:
providing a first active layer comprising a PVA polymer material;
providing a second active layer comprising PSA polymer material; and
irradiating the first active layer and the second active layer such that the first active layer and the second active layer are independently cross-linked, and the first active layer is cross-linked with the second active layer.

64. The method of claim 63, wherein the PVA polymer material further comprises a filler.

65. The method of claim 64, wherein the filler comprises a metal oxide powder, a silicate powder, or a combination thereof.

66. The method of claim 65, wherein the filler comprises a powder of zirconium oxide, titanium oxide, aluminum oxide, silicon oxide, aluminosilicate, calcium oxide, magnesium oxide, strontium oxide, barium oxide, or any combination thereof.

67. (canceled)

68. The method of claim 66, wherein the filler further comprises from about 5 wt % to about 50 wt % of zirconium oxide powder by weight of the PVA polymer material.

69. The method of claim 68, wherein the PVA polymer material further comprises a PVA co-polymer.

70. (canceled)

71. The method of claim 69, wherein the PVA co-polymer comprises polyvinyl alcohol-co-polystyrene sulfonic acid.

72. The method of claim 71, wherein the PVA co-polymer further comprises polyvinyl alcohol-co-polystyrene sulfonic acid, and the polyvinyl alcohol is present in a concentration of at from about 10 wt % to about 60 wt % by weight of the co-polymer.

73. The method of claim 68, wherein the PVA polymer material further comprises a mixture of PVA homopolymer or PVA co-polymer and at least one additional homopolymer or co-polymer.

74. The method of claim 73, wherein the PVA polymer material further comprises a mixture of PVA homopolymer and polyvinylsulfonic acid, polyacrylic acid, acrylic acid co-polymer, polyacrylamide, acrylamide co-polymer, polyvinyl amine, vinyl amine co-polymer, maleic acid co-polymer, maleic anhydride co-polymer, polyvinyl ether, vinyl ether co-polymer, polyethylene glycol, ethylene glycol co-polymer, polypropylene glycol, polypropylene glycol co-polymer, sulfonated polysulfone, sulfonated polyethersulfone, sulfonated polyetheretherketone, polyallyl ether, polydivinylbenzene, triallyltriazine, or any combination thereof.

75. The method of claim 68, wherein the PVA polymer material further comprises a PVA homopolymer.

76. (canceled)

77. The method of claim 75, wherein the PSA polymer material comprises polystyrene sulfonic acid homopolymer.

78. The method of claim 77, further comprising providing a third layer that comprises a second PVA polymer material.

79. An electrochemical cell comprising:
a cathode that comprises silver oxide,
an anode that comprises zinc,
an electrolyte, and
a multilayered separator that comprises a first active layer comprising a PVA polymer material and a second active layer comprising a PSA polymer material, wherein the active layers are independently cross-linked, and
the electrochemical cell is configured such that the second active layer is adjacent to the cathode.

80. An electrochemical cell comprising:
a cathode that comprises silver oxide,
an anode that comprises zinc,
an electrolyte, and
a multilayered separator that comprises a first active layer comprising a PVA polymer material and a second active layer comprising a QA polymer material, wherein the active layers are independently cross-linked, and
the electrochemical cell is configured such that the second active layer is adjacent to the cathode.

81. (canceled)
